(19) United States
(12) Patent Application Publication
(10) Pub. No.: US 2024/0044124 A1
(43) Pub. Date: Feb. 8, 2024

(54) System and Method for On-Site Construction Using Prefabricated Components

(71) Applicant: Innovate Prefabricate, Inc., Camden, DE (US)

(72) Inventor: Andrew C Bryant, New York, NY (US)

(73) Assignee: Innovate Prefabricate, Inc., Camden, DE (US)

(21) Appl. No.: 18/229,196

(22) Filed: Aug. 2, 2023

Related U.S. Application Data
(60) Provisional application No. 63/395,290, filed on Aug. 4, 2022.

(51) Int. Cl. E04B 1/02; E04B 1/61

(52) U.S. Cl. CPC E04B 1/02; E04B 1/6108; E04B 2001/6195

(57) ABSTRACT

A panelized, systems-based, holistic approach towards design, manufacturing and construction is disclosed. In an exemplary system, a core structural metal framing known as stud and track structure refers to the construction of walls and planes using cold-formed steel. The metal framing has two main components, a stud and a track. The disclosed system is a flat pack. A flat pack system is a prefabricated building construction system that uses structurally insulated panels which are prefabricated in a factory, shipped by stacking and assembled on site. The modular panel system is manufactured off-site and includes an exterior facade, insulation and interior walls in a single pre-made modular panel system, which is connected via novel connectors.

### BACKGROUND OF THE INVENTION

Various technologies are available to support the building and construction sector and to complete projects quickly and effectively; however, existing tools are largely underutilized. On-site traditional construction methods typically result in long build times and waste. Traditional building methodologies rely primarily on heavy machinery and human labor in conjunction with outdated techniques. Current construction practice also results in worker fatigue due to excessive amounts of physical strain which in turn leads to an increased risk of injuries on site.

Existing prefabricated solutions only address mass-manufacturing, but do not offer enough design flexibility to meet the needs of communities, developers and agencies providing housing and facilities in diverse urban spaces. The majority of prefabricated housing is built using block modules, which allows limited flexibility in different configurations, sizes and design. Block modules are volumetric which increases shipping costs, and requires heavy machinery for installation. These block module methods are especially difficult to use in areas where heavy machinery cannot be deployed, excluding a large market of smaller lots between buildings, also known as infill lots, from the benefits of existing prefabricated building techniques.

Logistical issues, waste materials and reduced productivity are the unintended consequences of using these known methods. These shortcomings not only impact the project but also impact environmental and human health as well. For example, the construction sector's greenhouse gas (GHG) emissions account for approximately 40% of global GHG emissions with approximately 11% directly correlated to building construction. Additionally, half of waste materials accumulated during construction in the U.S. are not reused or recycled and end up in landfills, with wood and brick having the lowest reuse profile.

Standard post construction methods do not take into account a building's lifecycle reuse value and environmental impact. Current construction practices have remained relatively unchanged for the last 70 years, operating at low rates of efficiency which in turn affects the amount of time needed to complete a project, increases the amount of energy consumed during the construction of a project and results in higher costs and excessive waste.

What is needed, therefore, is a system and method of construction technologies integrated with a systemic, holistic approach towards how a building is constructed and which reduces costs, waste and carbon emissions while increasing efficiencies, quality and safety.

### SUMMARY OF THE INVENTION

The aforementioned shortcomings are addressed in a panelized, systems-based, holistic approach towards design, manufacturing and construction. In an exemplary system, a core structural metal framing known as stud and track structure refers to the construction of walls and planes using cold-formed steel. The metal framing has two main components, a stud and a track.

The disclosed system is a flat pack. A flat pack system is a prefabricated building construction system that uses structurally insulated panels which are prefabricated in a factory, shipped by stacking and assembled on site. The modular panel system is manufactured off-site and includes an exterior facade, insulation and interior walls in a single pre-made modular panel system, which is connected via novel connectors.

A system and method according to the principles of the invention results in the following and other advantages over known constructions methods:

Increases the ease and speed of assemblage by approximately 200% or more and increases worker safety through the use of discreet, light weight panels and proprietary connectors. The panels and connectors increase ease of assemblage on site, increase the accuracy of alignment between panels and decreases the fasteners required to fix panels to each other on site.

Reduces material waste through a more efficient use of raw materials during the panel manufacturing process and through providing solutions for recycling and upcycling materials used.

Lowers carbon emissions through elimination of the need for heavy equipment during installation, through the use of bolt and screw fasteners only (no or reduced welding) and by reducing transportation costs for shipment of materials through use of a flat pack panel system.

Allows for easier replacement of panels (both exterior and interior) post occupancy.

Integrates in a digital toolkit which allows for a precise calculation of materials needed and increases efficiency in production timelines. Direct to manufacturing workflows also reduces waste and worker fatigue thereby increasing production capabilities.

Both the hardware and software components of construction contribute to generating efficiency and sustainability. The disclosed exemplary system includes an integration of hardware and software components, a panelized prefabricated modular building system combined with a digital design toolkit software. In a system and method according to the invention, the hardware and software integration achieves an unexpected synergy in increasing construction efficiency and reduction in waste and environmental impacts.

The hardware components include a series of standardized modular walls, windows, doors, floors and roof panels connected by a series of proprietary and off the shelf connectors. The connectors include ties for lateral connections, novel integrated hanger and tie connectors for load bearing wall to floor joist connections, roof joist to roof joist connections and roof joist to load bearing wall connections. Exemplary standardized panels are 1 meter in width, although the skilled artisan will appreciate that other widths may be used without departing from the invention. The relatively narrow panels facilitate installation by hand and differ from panel systems currently available. (Known panel systems are much wider and require heavy cranes, typically of over 5,000 pounds capacity, to be lifted into place.) Connectors according to the invention that tie the wall panels together allow for easy alignment on site, as well as for reduced assemblage time, reduced on site complexity and reduced number of fasteners required to connect the panels to each other.

The structural connectors and panels according to the invention can be unfastened, reused and upcycled, addressing materials' end of lifecycle. Additionally, this system allows for the customization to expand or reduce a build based on current or future needs of the inhabitant(s) by unfastening and reconfiguring panels. Existing prefabricated solutions only address mass-manufacturing but do not offer enough design flexibility to meet the needs of communities, developers and agencies providing housing and facilities in diverse urban spaces. The panelized system according to the invention provides greater design flexibility than box-modular prefabricate but is simpler and up to 50% faster to construct than pre-framed prefabricate or traditional construction techniques. This flexibility means that construction systems and methods according to the invention can design and build homes and neighborhood functions that are as unique as their communities while ensuring lower costs, ease of construction and sustainability enhancements.

The exemplary digital toolkit makes use of geolocated workspace in which the proprietary kit-of-parts panel designs, configurations and materials are all encoded. It allows our users to generate, visualize and analyze buildings, from their code compliance to their sustainability credentials and cost efficiency. The digital design toolkit also allows us and our users to keep track of the materials and their embodied energies, resulting in one of the most comprehensive built-environment life-cycle carbon tracking projects today.

The software component is a digital toolkit software that employs generative design algorithms and accurate digital representation of panel system components. Test-fits for new sites and volumetric designs can be generated in minutes rather than days and fully engineered plans output in a few days rather than months. Site specific data can be input, including site boundaries, zoning height restrictions, site topography and daylighting information. The toolkit can automatically generate a building envelope massing, and based on this massing, generate standardized, modular floor, wall, windows, doors and roof panels encapsulated in a 3D BIM model.

Floor to floor heights can be adjusted based on the project requirements and an inventory of structural component parts (i.e. tracks, studs, floor joists, roof joists, window and door dimensions, building insulation, façade materials and interior finishes) can be generated both as an excel data file and as a digital 3D CAD file that can be sent straight to the manufacturer for output using advanced automated CFS (cold formed steel) manufacturing equipment. BIM or Building Information Modeling is a process for creating and managing information on a construction project throughout its lifecycle. This includes seamless integration with BIM and computer aided manufacturing where 3D BIM model information is input directly into factory-controlled software and advanced roll-forming manufacturing equipment. The toolkit reduces the amount of time needed for design and engineering development drawings, and reduces the amount of waste through providing an accurate and precise inventory of dimensions, quantities and weight of materials used.

The panelized modular build system with its generative design toolkit can significantly reduce design and build costs while changing how buildings integrate and interact with humans and the environment throughout its lifecycle.

### BRIEF DESCRIPTION OF THE DRAWINGS

Although the following figures depict various examples of the invention, the invention is not limited to the examples depicted in the figures.

In the figures:

FIG. 1 is a schematic diagram illustrating a standardized panel assemblage system according to the principles of the invention, including wall panels, floor panels, roof panels, door panels, windows panels and associated connectors which tie the panels to each other (both horizontally and vertically).

FIG. 2 is an exploded schematic diagram with typical sectional details illustrating exemplary standardized panel connections based on a typical structural bay for roof joist to load bearing wall panel connections and load bearing wall to load bearing wall panel connections.

FIGS. 3, 3.1 and 3.2 are diagrams and architectural drawings for an exemplary flat pack, standardized load bearing wall panels, with a typical panel plan, section and exploded standardized wall panel diagram with material references.

FIGS. 4, 4.1 and 4.2 are diagrams and architectural drawings for a flat pack, standardized load bearing floor panels, with a typical panel plan, section and exploded standardized wall panel diagram with material references.

FIGS. 5, 6 and 7 are a set of diagrams and architectural drawings for a flat pack, standardized wall panels, with a typical panel drawing perspective and an exploded standardized wall panel diagram with material references.

FIGS. 8, 9 and 10 are a set of diagrams and architectural drawings for a flat pack, standardized window panels, with a typical panel drawing perspective and an exploded standardized wall panel diagram with material references.

FIGS. 11, 12 and 13 are a set of diagrams and architectural drawings for a flat pack, standardized window panels, with a typical panel drawing perspective and an exploded standardized wall panel diagram with material references.

FIGS. 14 and 14.1 are a set of diagrams and architectural drawings for a connector that ties the roof panels at the apex of the pitch.

FIGS. 15 and 15.1 are a set of diagrams and architectural drawings for a connector that ties the roof panels to the load bearing wall panels.

FIGS. 16 and 16.1 are a set of diagrams and architectural drawings for a connector that ties the floor joist panel to load bearing wall panels and which ties the load bearing wall panels vertically to other load bearing wall panels, windows panels and roof panels.

FIG. 17 is are a set of diagrams and architectural drawings for a panel tie that ties the roof panel to other roof panels (both horizontal and vertical connections).

FIGS. 18 and 18.1 are a set of diagrams and architectural drawings for a panel tie that ties a wall panel to other wall panels (both horizontal and vertical connections).

FIG. 19 is a Generative Digital Toolkit systems flow diagram which outlines how project data is processed for use with three-dimensional, flat pack, cold formed steel panel systems invention.

### DETAILED DESCRIPTION

A system, method, and method of manufacture for a three-dimensional, flat pack cold formed steel panel system that utilizes smaller panels sizes and integrated, bespoke connectors to tie the panels together are described herein. The following detailed description is intended to provide example implementations to one of ordinary skill in the art and is not intended to limit the invention to the explicit disclosure, as one of ordinary skill in the art will understand that variations can be substituted that are within the scope of the invention as described.

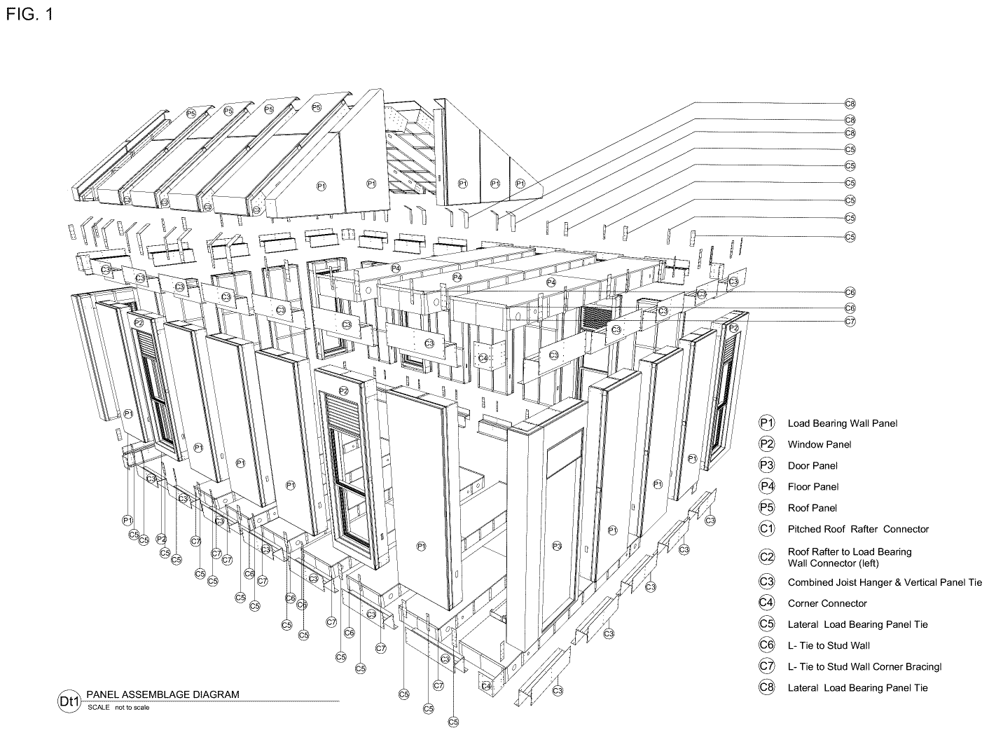

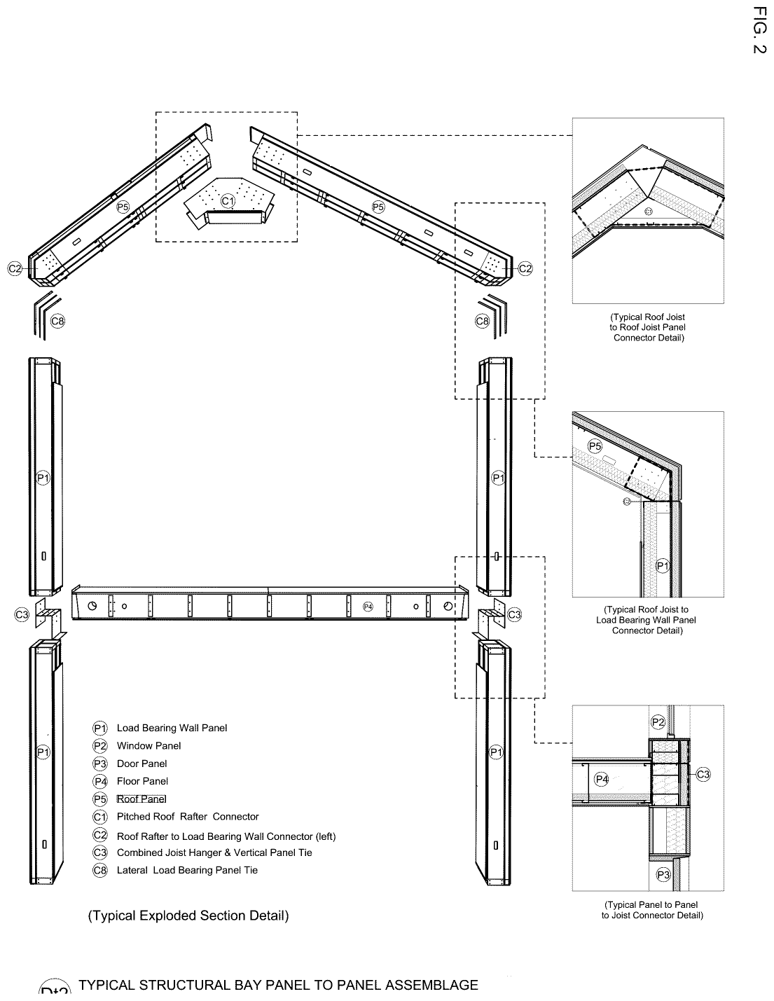

System Overviews (FIGS. 1 and 2)

Current Cold Formed Steel (CFS) on site installation of prefab components rely on heavy equipment such as cranes to erect panels or box modules in place. While this is an improvement from standard, in situ construction, it still is approaching construction as parts that are discreet and not taking into consideration the overall system as integrated. Current CFS manufacturing also relies on use of heavy equipment, such as cranes, and extensive and physically taxing human labor for installation, including alignment of single parts on site by hand and screwing, bolting or welding in individual fasteners to make the connections. The quantity of fasteners required for installation of hangers and ties to connect panels together on site easily amounts to tens of thousands of screws for a low rise, cumbersome and often times inaccurate alignment of panels to panels and overall, increase worker fatigue and potentials for injury on site.

The present embodiment of the invention approaches the assemblage as a systems-based approach and looks at the entire system from a holistic perspective, using connectors and panel sizes to eliminate or severely reduce the amount of heavy equipment required for installation, facilitating use of less fasteners on site, reducing worker fatigue, increasing worker safety and increasing efficiency of overall construction schedules by at least 50%.

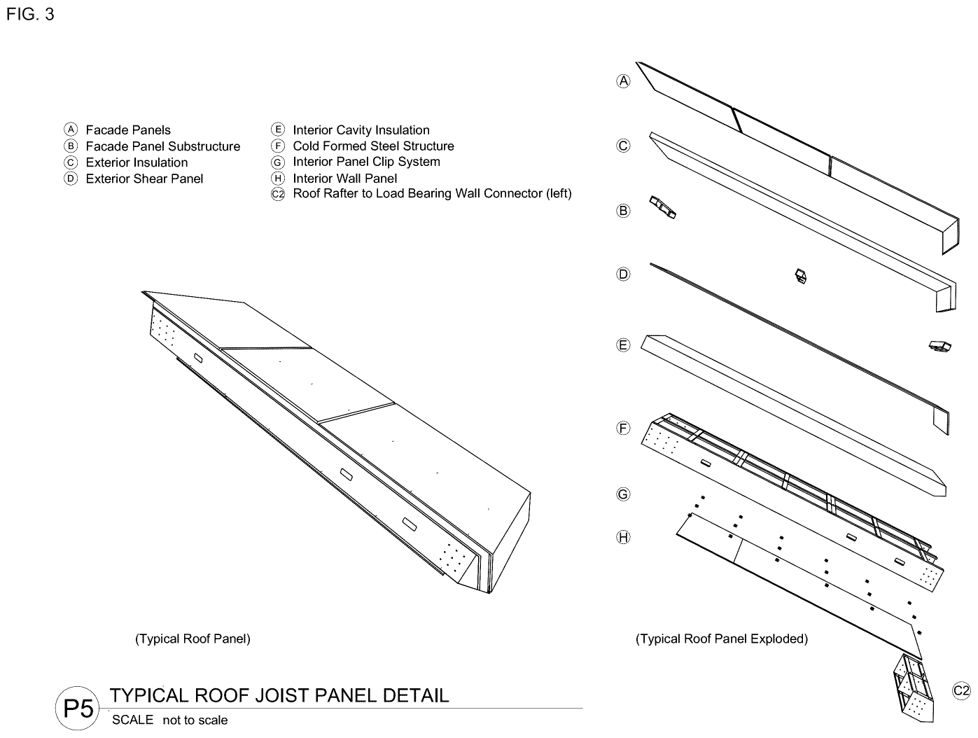

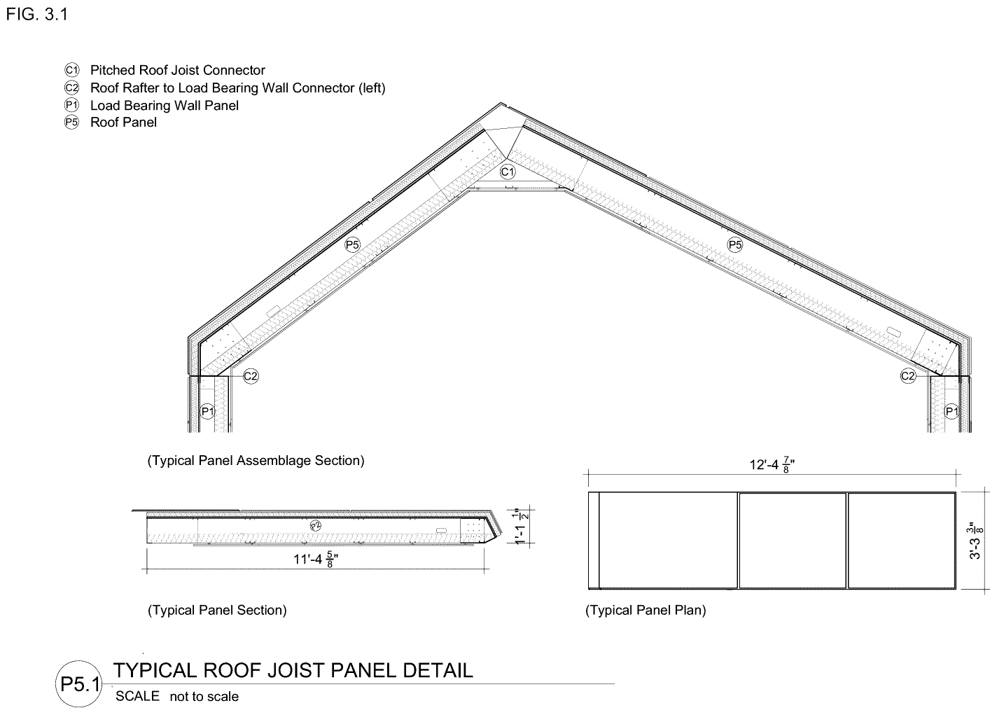

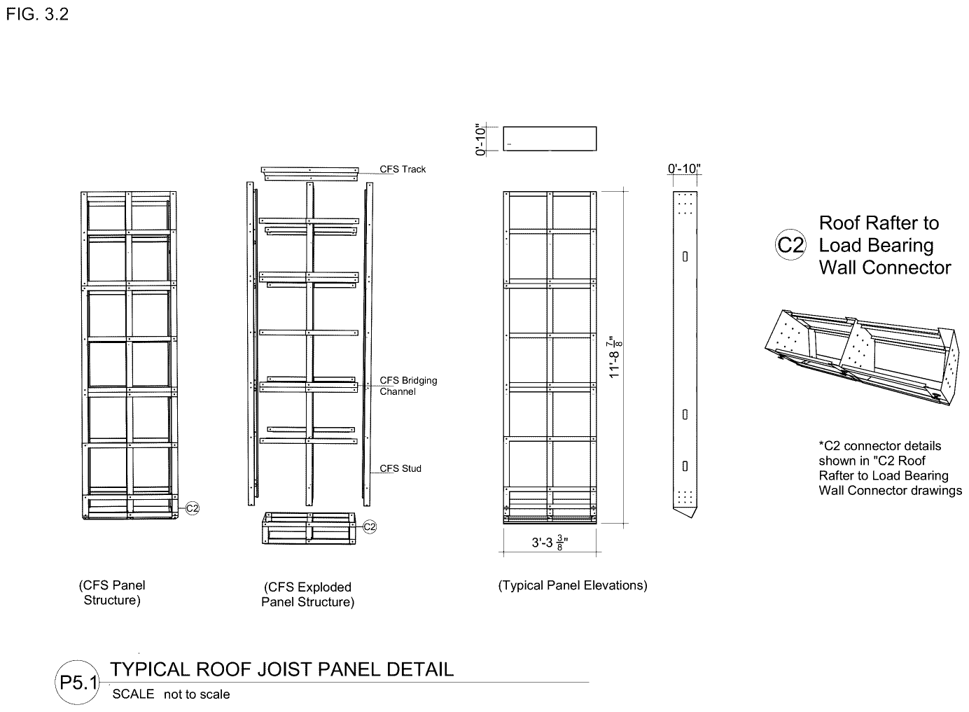

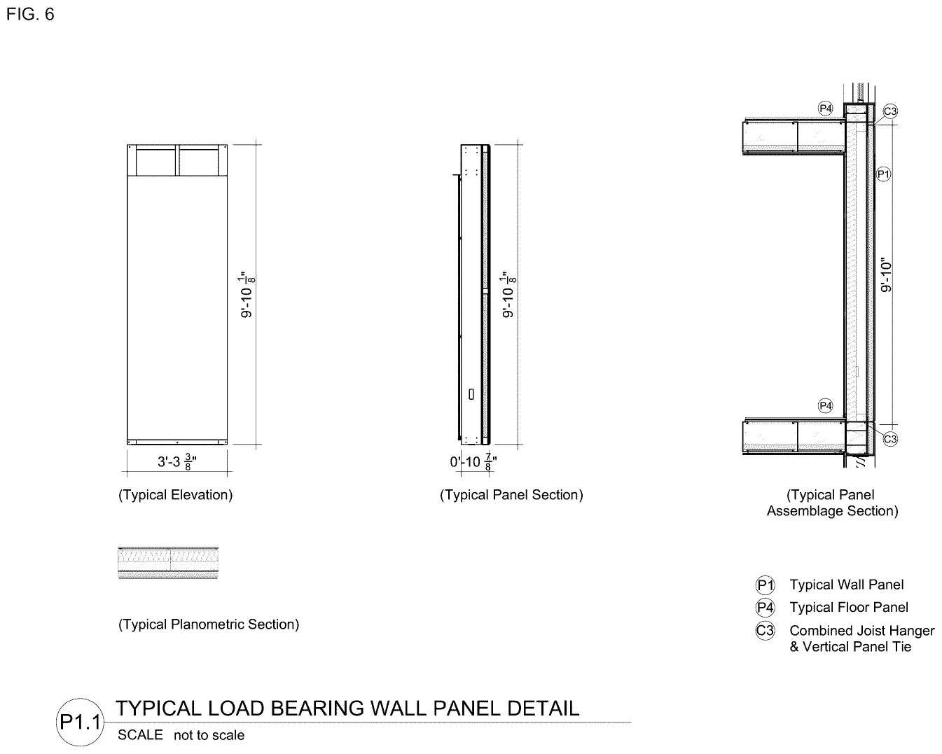

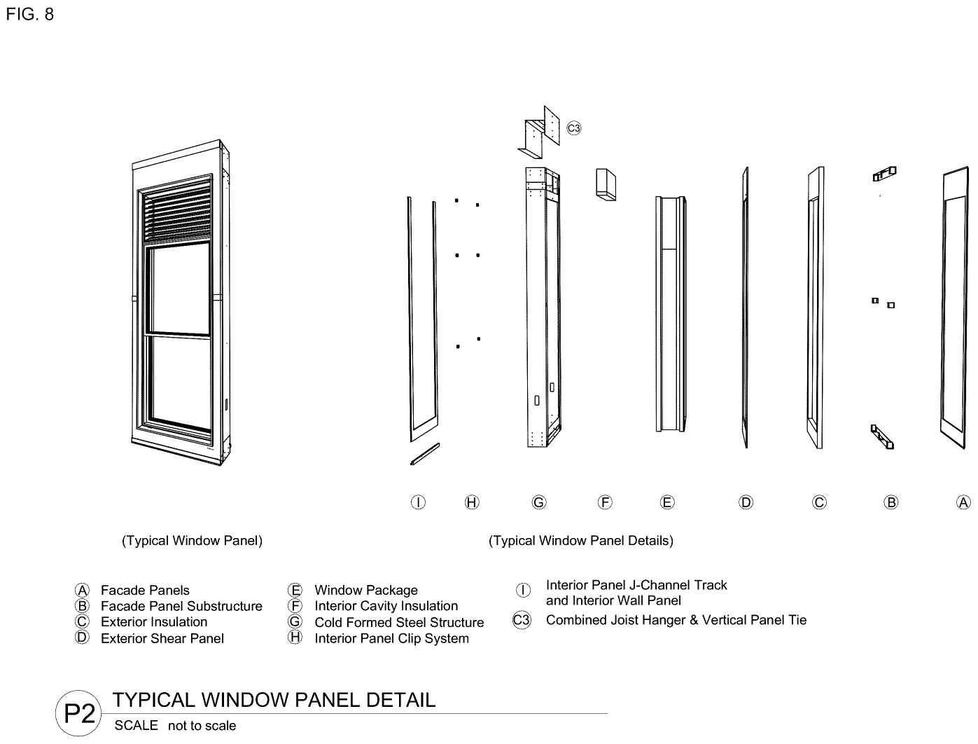

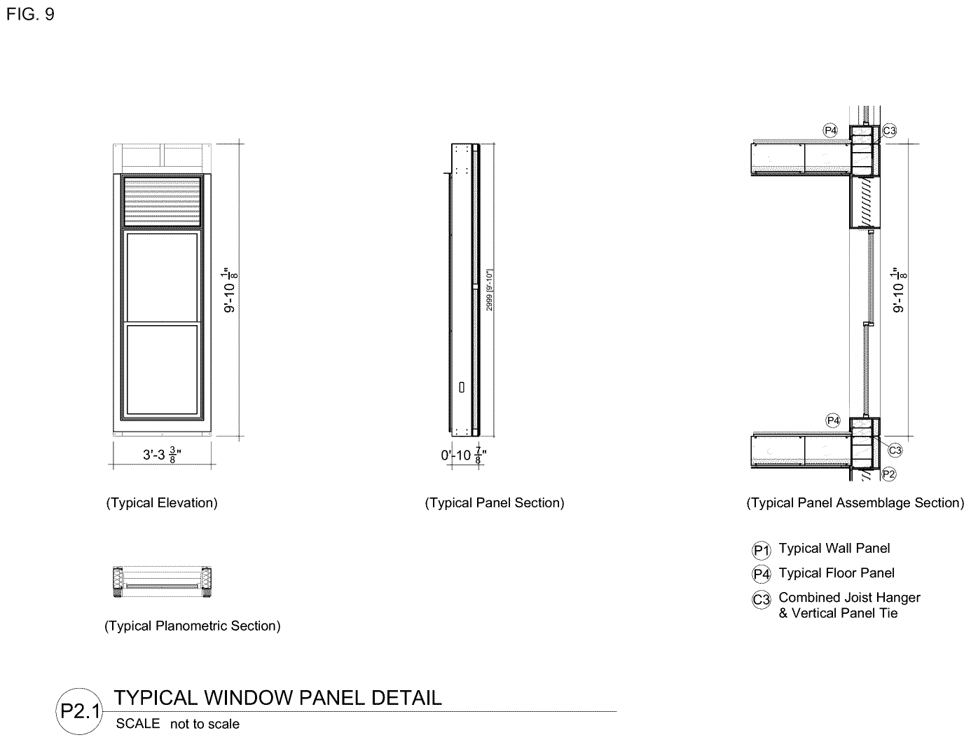

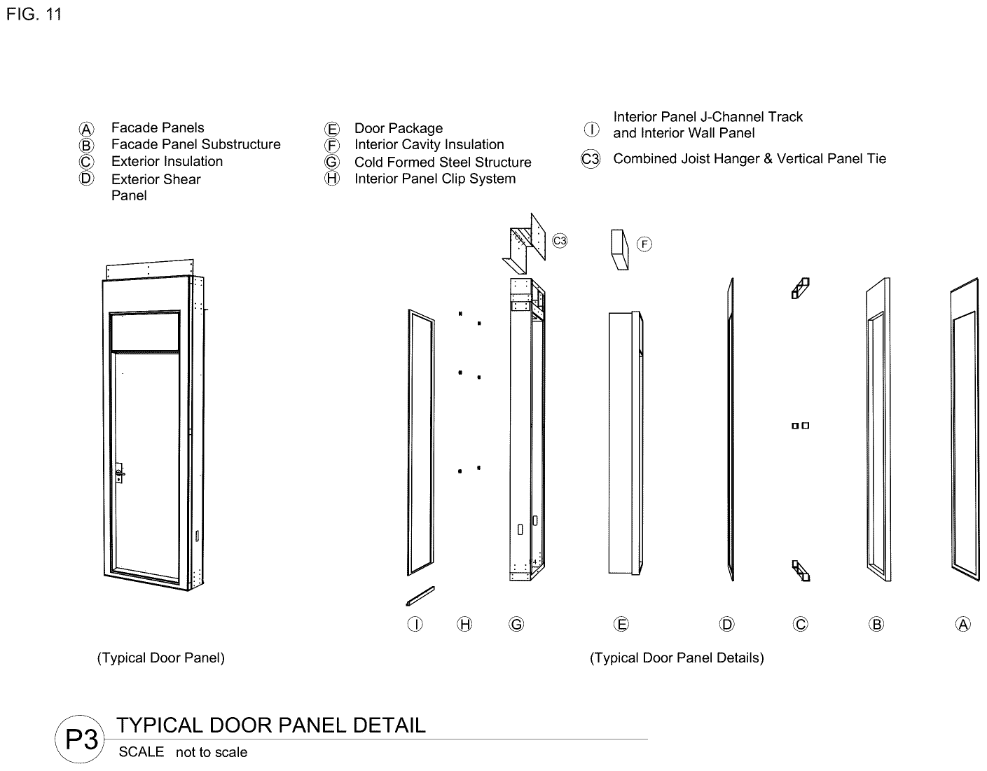

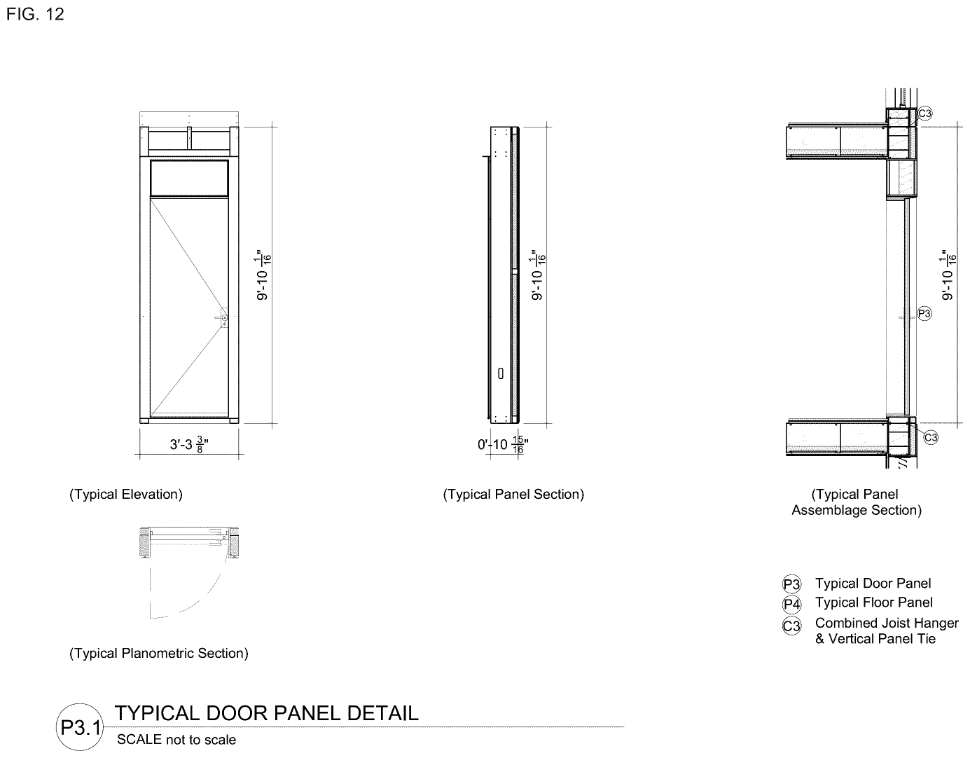

Figures land 2 are schematic diagrams illustrating cold formed steel framed panel assemblage system, according to embodiments of the invention. The panels are a composite of load bearing cold formed steel structural members (i.e tracks, studs, transoms, cross bracing ties for lateral stability) and bespoke connectors which connect the panels together. All panels are preassembled in the factory and are standardized as to floor, wall, ceiling, roof, door and window panels (refer to FIGS. 3-13).

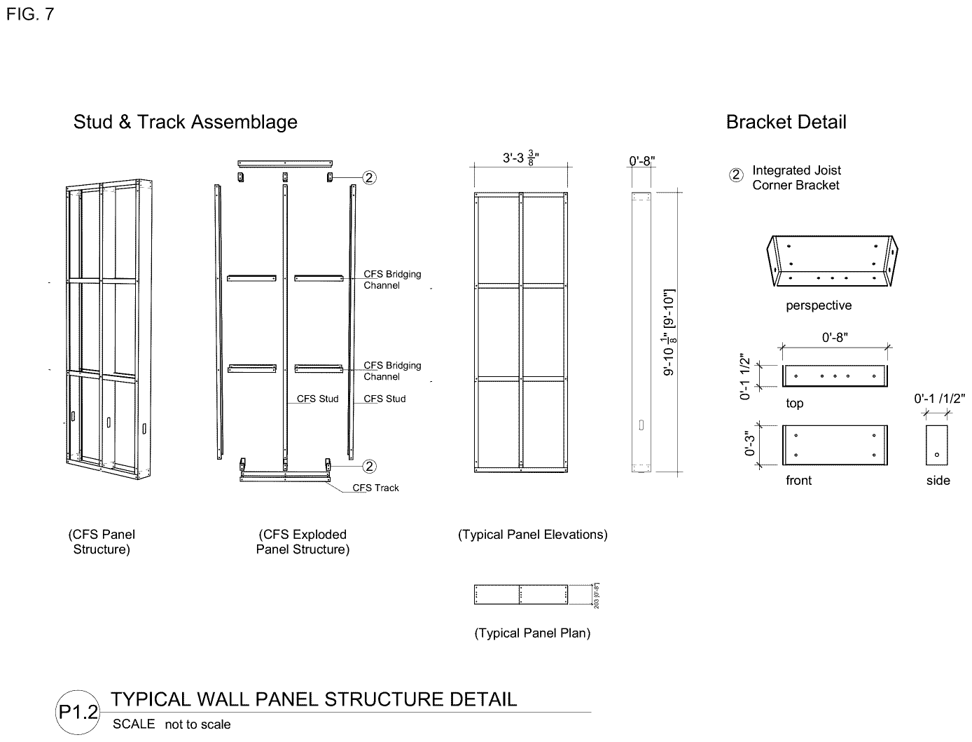

Each standardized panel is comprised on a cold formed steel framing structure with cavity insulation, external shear panels, external insulation (located on the exterior of panels, FIGS. 7, 10 and 13), water proofing vapor barrier, a modular clip-on façade substructure and a modular interior clip-on system for attaching interior wall and ceiling finishes. Façade panels and interior finish panels are installed on site with the substructure pre-mounted onto the façade and interior finish panels for quick installation on site, minimizing the fasteners required (FIGS. 3, 4, 7, 8 and 11). All on site assemblage makes use of bolt and screw fasteners and requires no welding.

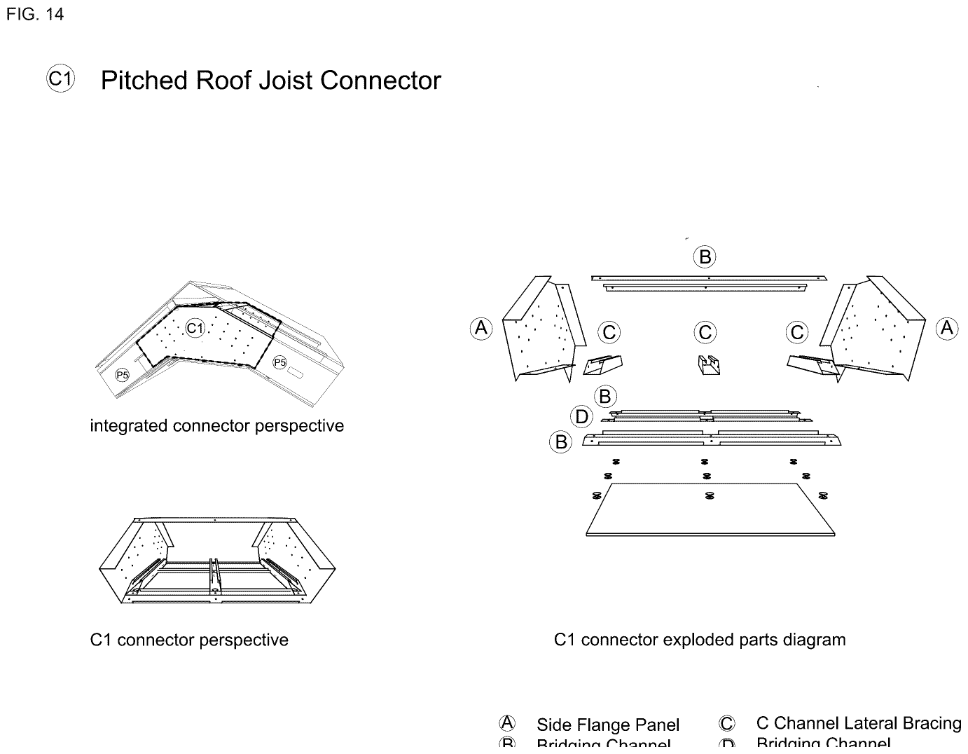

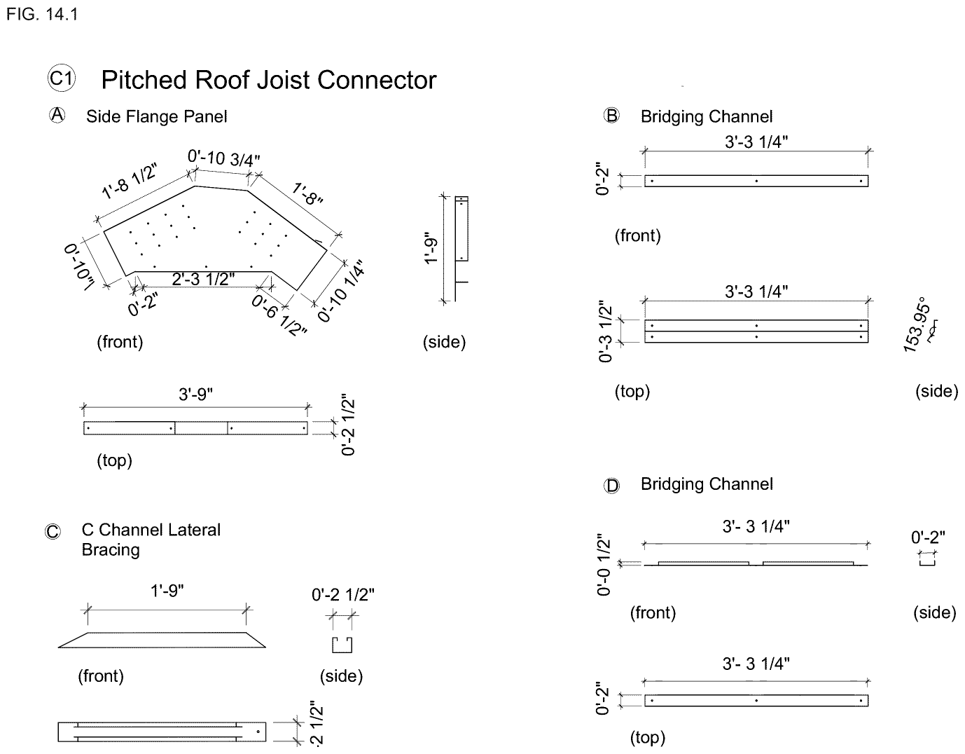

The connectors form a component part of the assemblage process, allowing for accurate alignment on site and quick installation (refer to FIGS. 14-18), helping to provide solutions for issues that commonly occur in situ when aligning panels to be fastened to each other, reducing injury on site by reducing the complexity of assembling many component parts on site, allowing for upgrades to panels post construction through the novel connectors that accommodate quick dis-assemblage and accommodating upcycling and recycling of panels once the building has reached its lifecycle and its use is obsolete (FIGS. 14, 15, 16, 17, 18 & 19).

The panel sizes eliminate the need for heavy equipment (such as cranes) while reducing the complexity of installation on site (i.e. less parts to inventory, track and store on site while waiting for use in assemblage) as well as lower the overall building construction carbon footprint by elimination of the need for welding on site, minimizing the amount of transportation required to transport panels from the factory to the construction site through use of flat pack, panels which are smaller in size (FIGS. 3, 6, 9 and 12) and which more efficiently pack into containers or trucks, reducing the overall amount of volumetric shipment required and reducing the amount of fuel needed for transportation and for operating heavy equipment for installation.

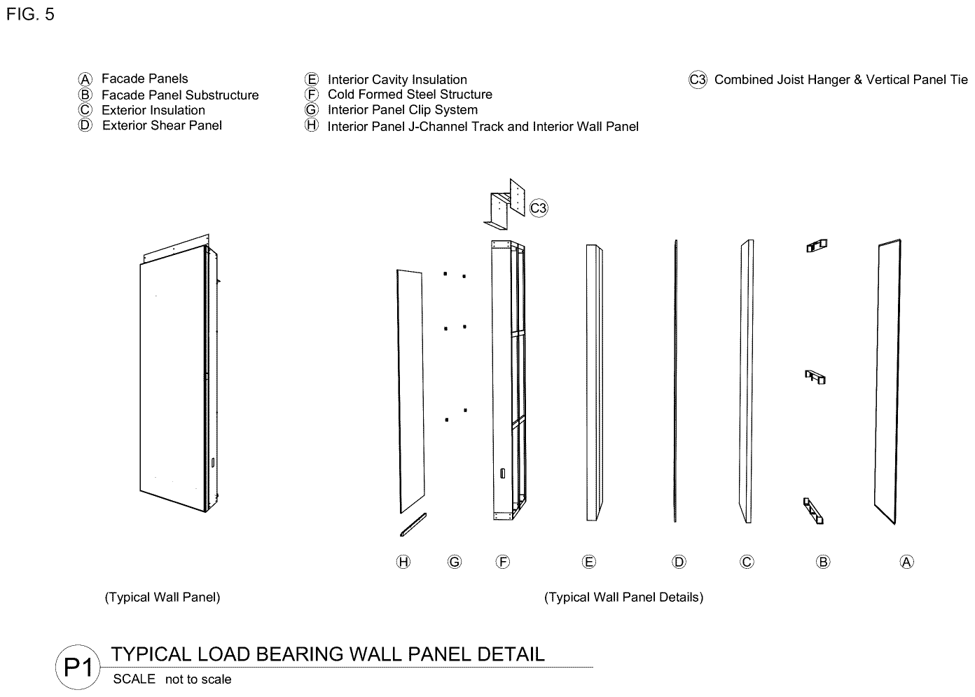

The standardized wall panel framing (FIGS. 5, 6 and 7) make use of a bespoke bracket that helps with alignment of connection of the panels, reduces stress on screws through the design of a corner connecting bracket (FIG. 7, “Bracket Detail”) which reduces the amount of shear stress on individual screws or bolts by distributing the shear stress across the entire bracket plates thereby reducing the amount of stress on the screws and through increasing the accuracy of the corner alignments between the panel tracks and studs.

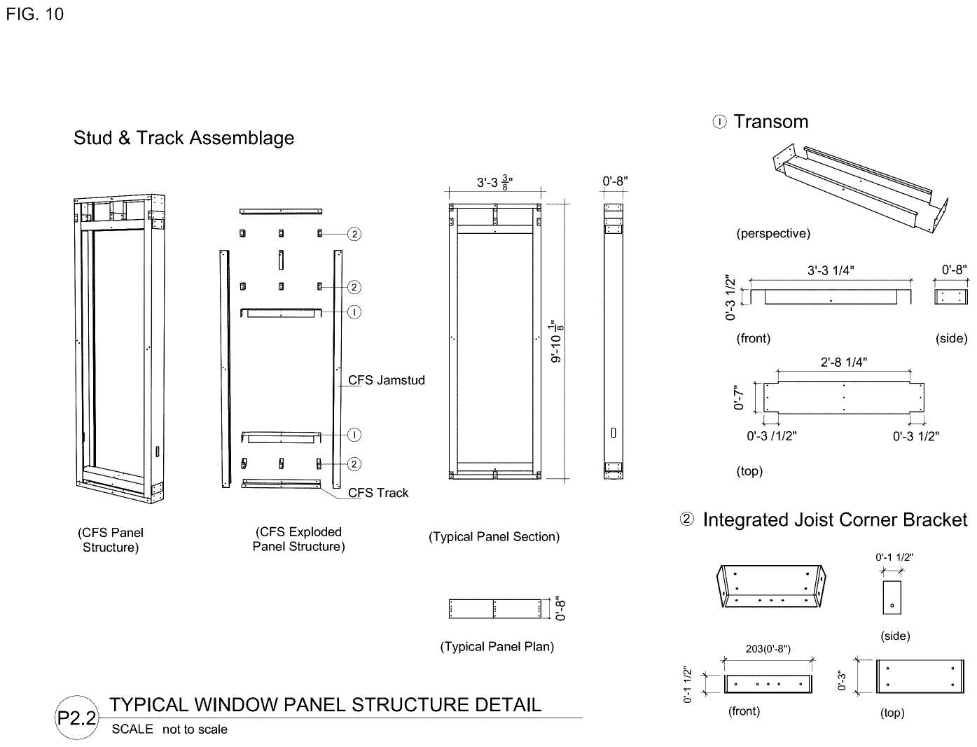

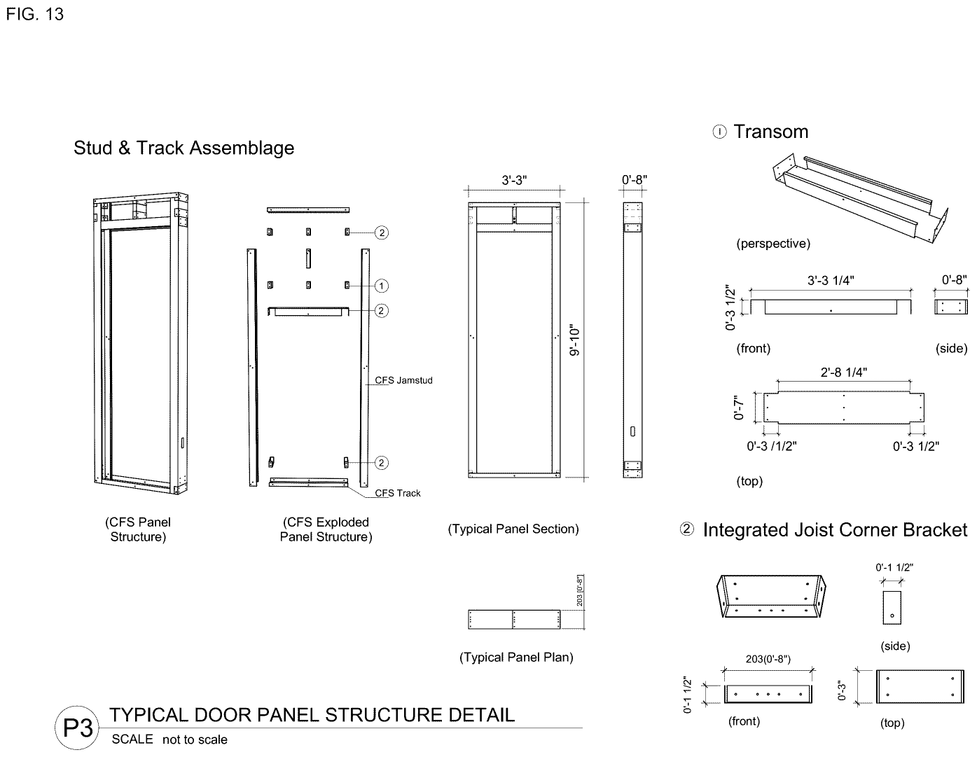

The standardized window and door panel framing utilizes the same principle of the wall framing by way of the corner connecting bracket (FIG. 7, “Bracket Detail) while also utilizing a transom (FIGS. 10 and 13) at the top of the window frame to transfer vertical loads from the panels above to side jam studs.

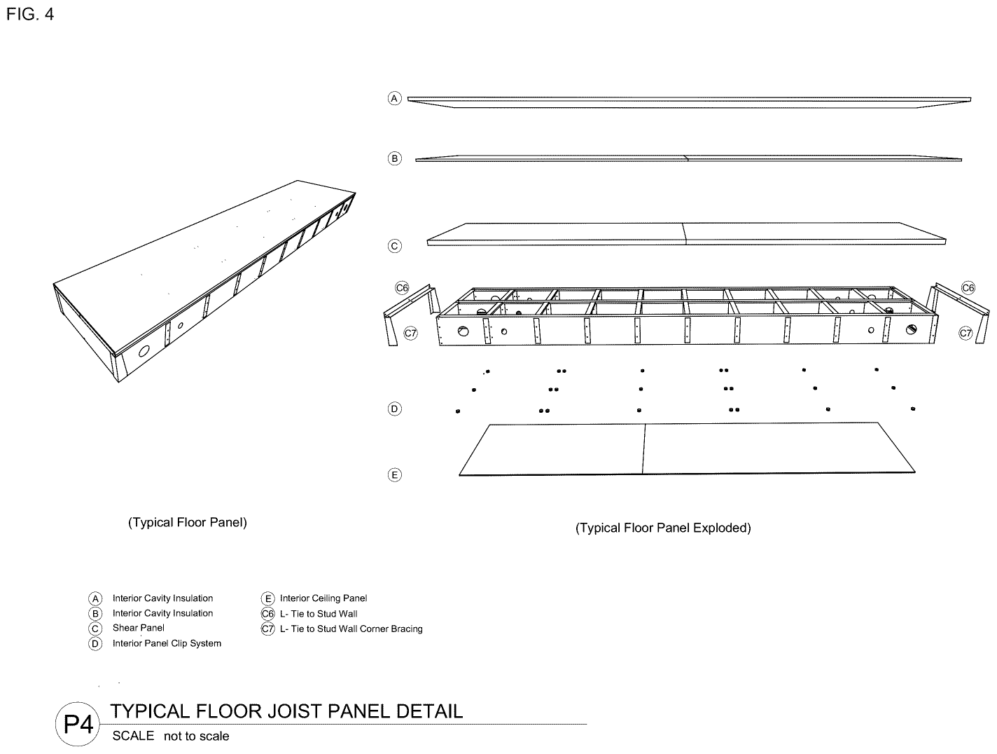

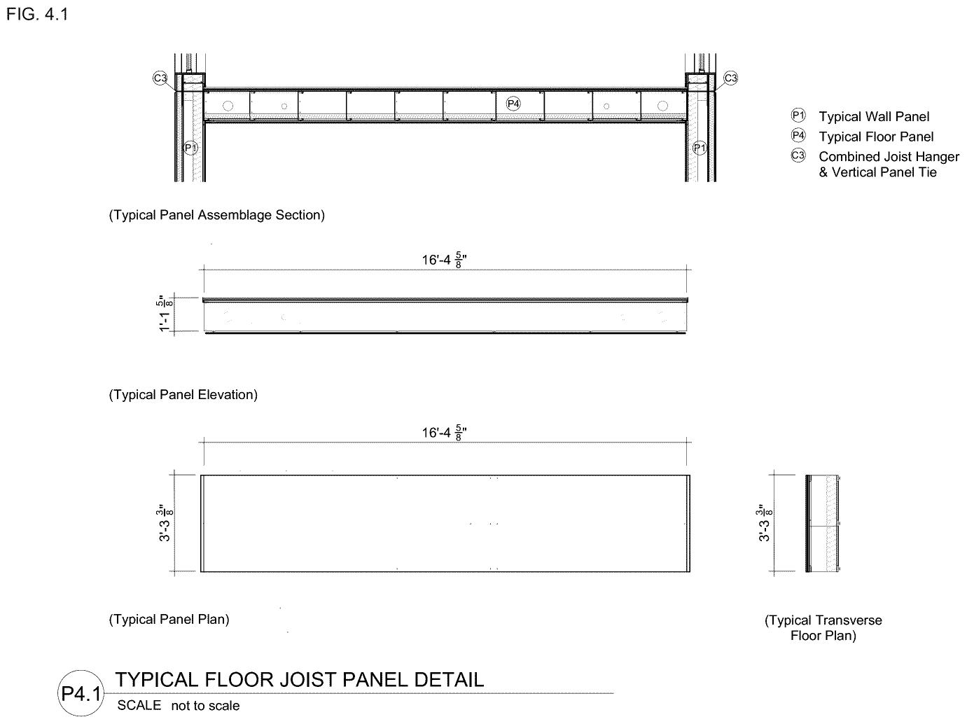

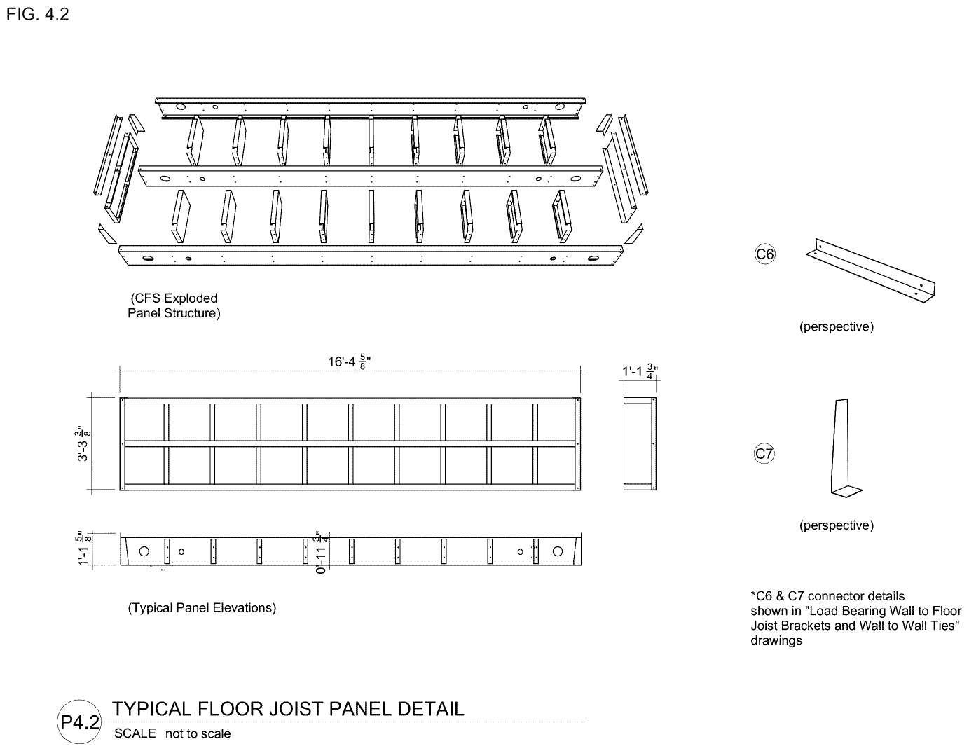

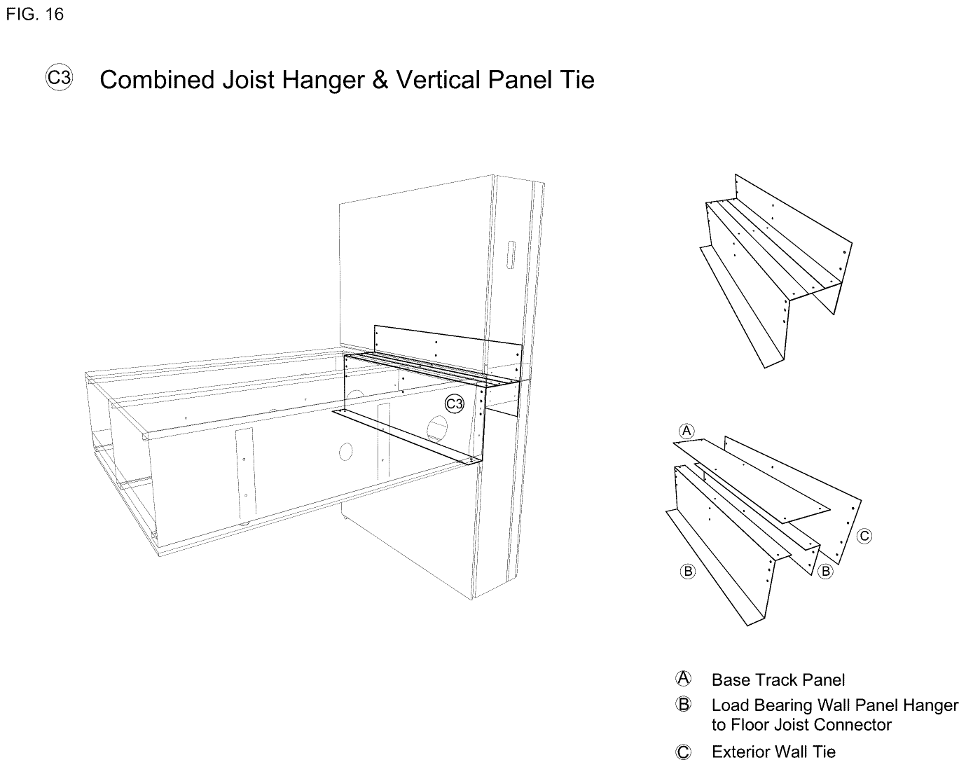

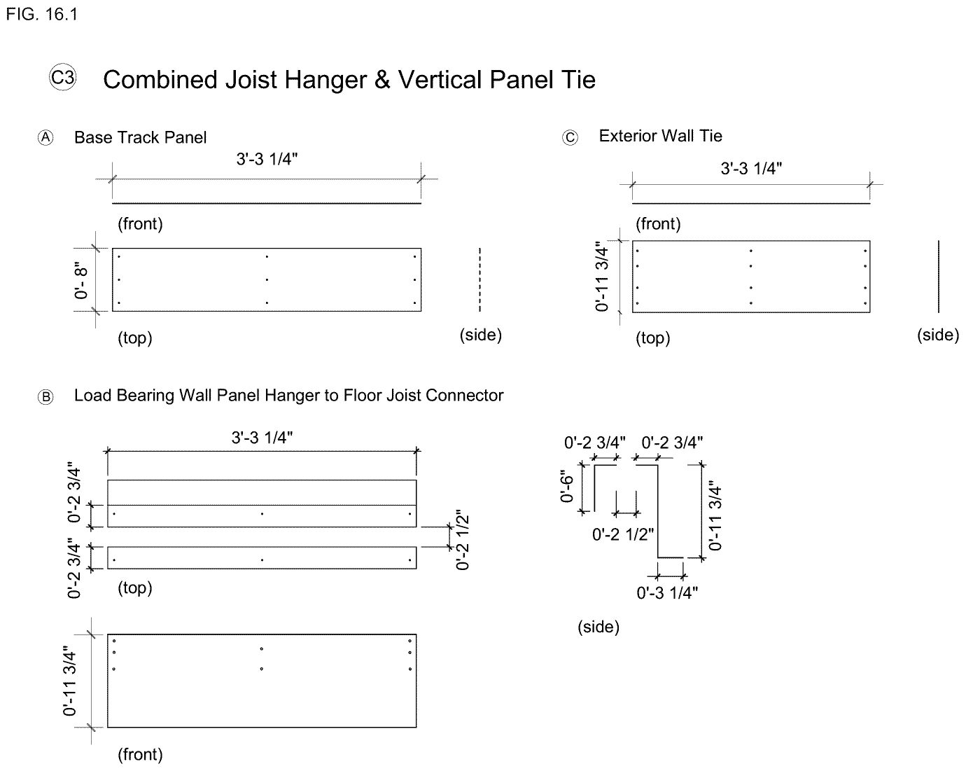

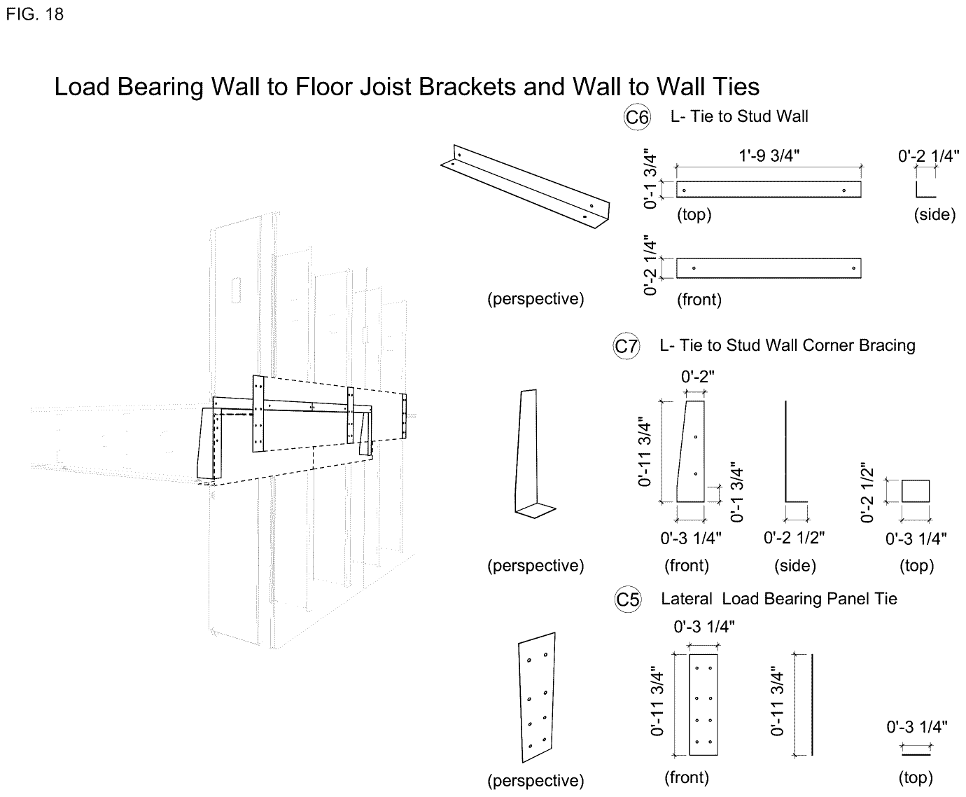

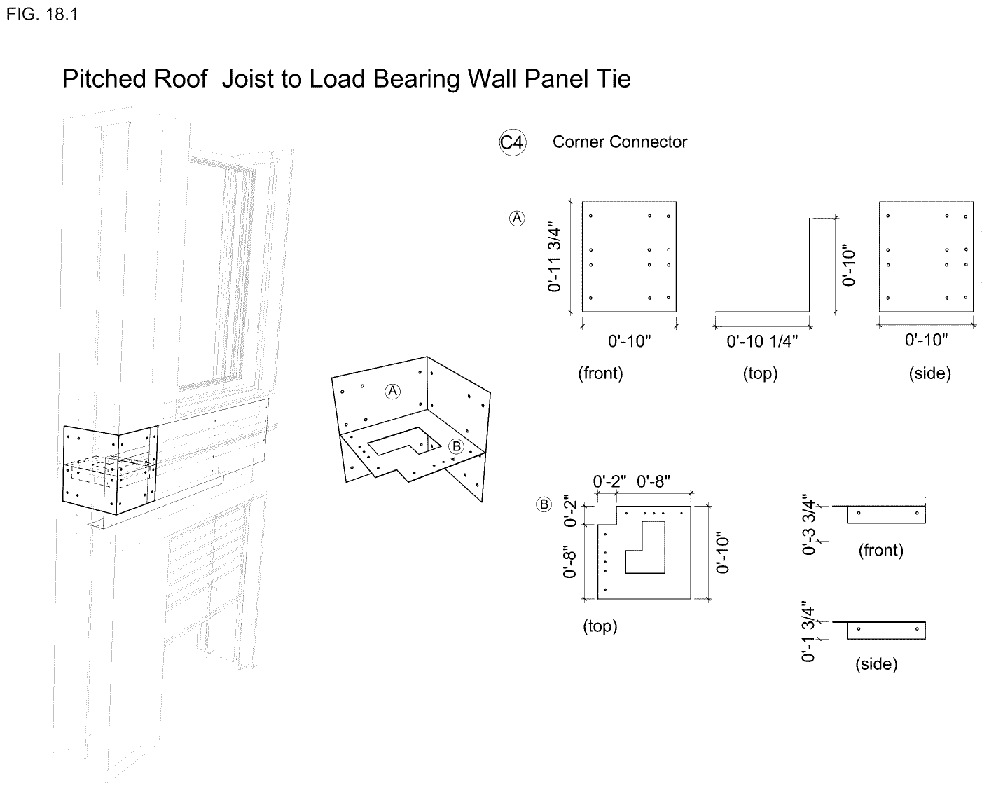

The standardized floor panels use CFS, c-channel joists which are connected together at either end, a CFS c-channel cap with bridging channels for lateral stability and end “L brackets” (FIG. 18, C7) for corner alignment and corner rigidity. Connections may be fastened with screws or welded in the factory (FIG. 4.2). The floor joists are connected or hung from load bearing wall panels on either side (FIGS. 2 and 4.1) by a combined Joist Hanger and Vertical Panel Tie (FIG. 16). The Hanger (FIG. 16B) may be preinstalled in the factory to the load bearing wall, window or door panels (FIGS. 5, 8 and 11) and connected on site to the floor joist (FIGS. 4, 4.1 and 4.2) by screw fasteners.

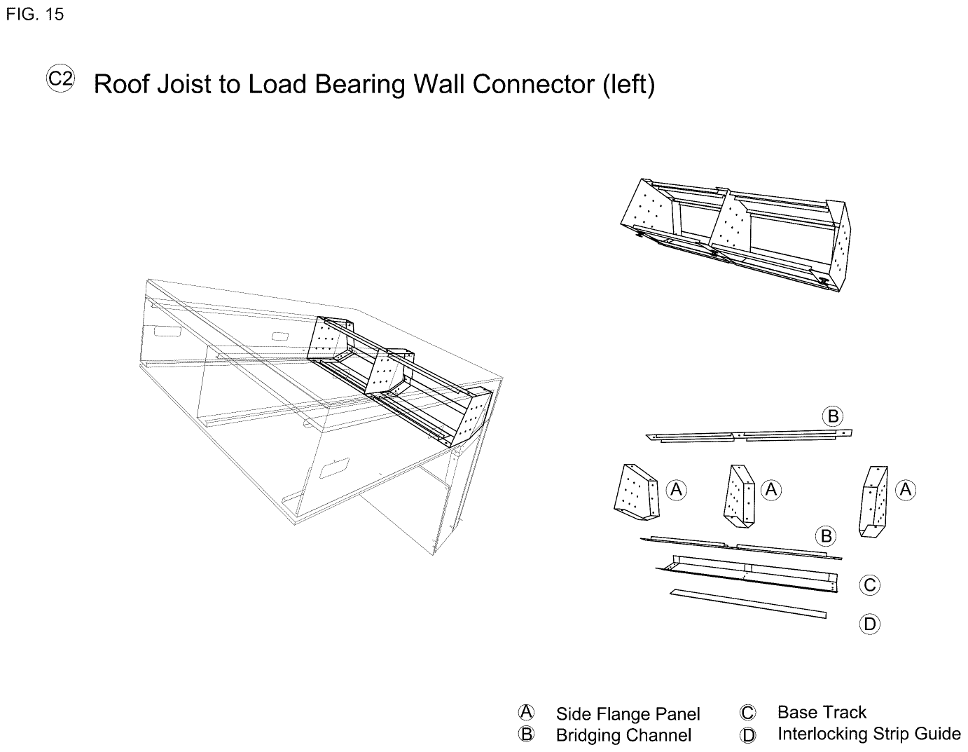

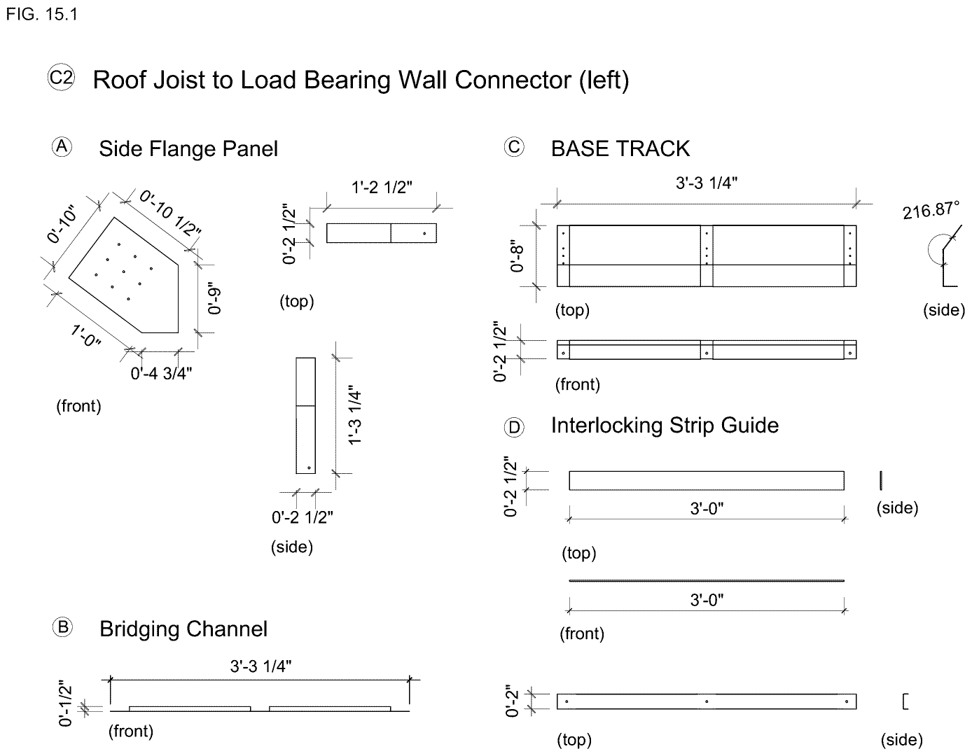

The standardized pitched roof panels use CFS, c-channel joists which are connected together at either end, a CFS c-channel cap with bridging channels for lateral stability and which are connected at the base (to the load bearing wall panel) by a Roof Joist to Load Bearing Wall Connector (FIGS. 2 and 15) and at the apex of the roof by a Pitched Roof Joist Connector (FIG. 14). The CFS roof panel may be fastened with screws or welded in the factory (FIG. 3.1).

The Pitched Roof Joist Connector (FIG. 14) is comprised of 2 side flanges (FIG. 14, A) with a series of bridging channels (FIGS. 14, B and D) and bracing c-channels (FIG. 14, C) for lateral stability and is installed on site. This connector mitigates the need to cut the roof joists at angles at the apex where the roof panels connect, providing more precise alignment and easier installation on site by hand using screw fasteners. The Roof Joist to Load Bearing Wall Connector (FIG. 15) utilizes the same principles as the Pitched Roof Joist Connector (FIG. 14) and is comprised of 3 flanges (FIG. 15, A), uses bridging channels (FIG. 15, B) and a base track (FIG. 15, C) and may be installed in the factory as a part of the Roof Panel (FIGS. 2 and 15).

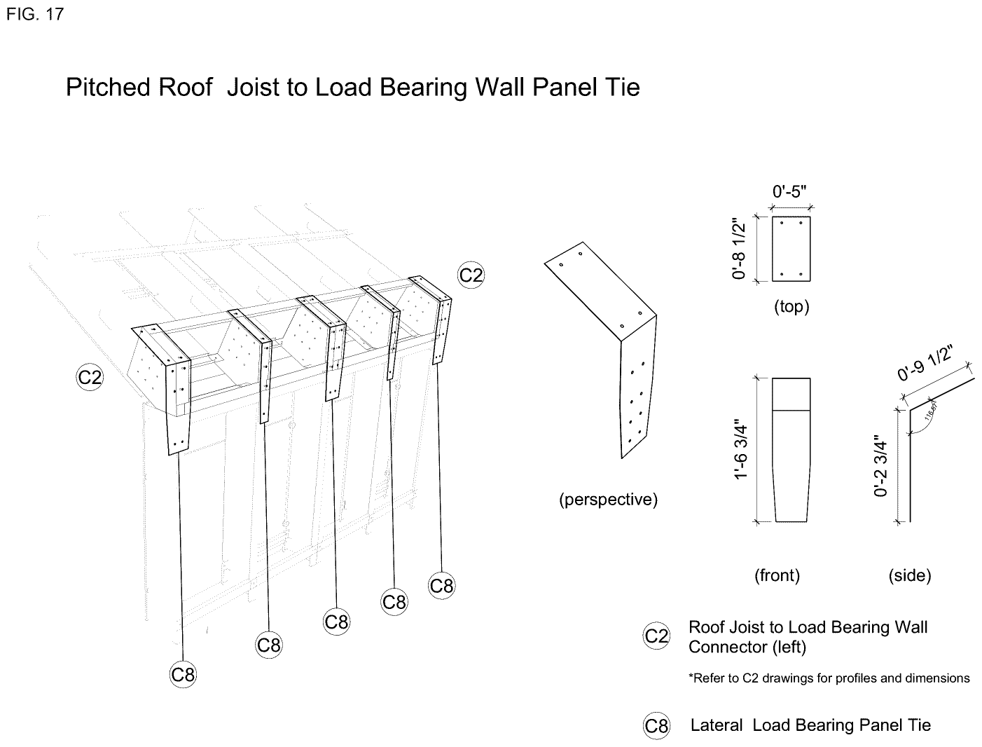

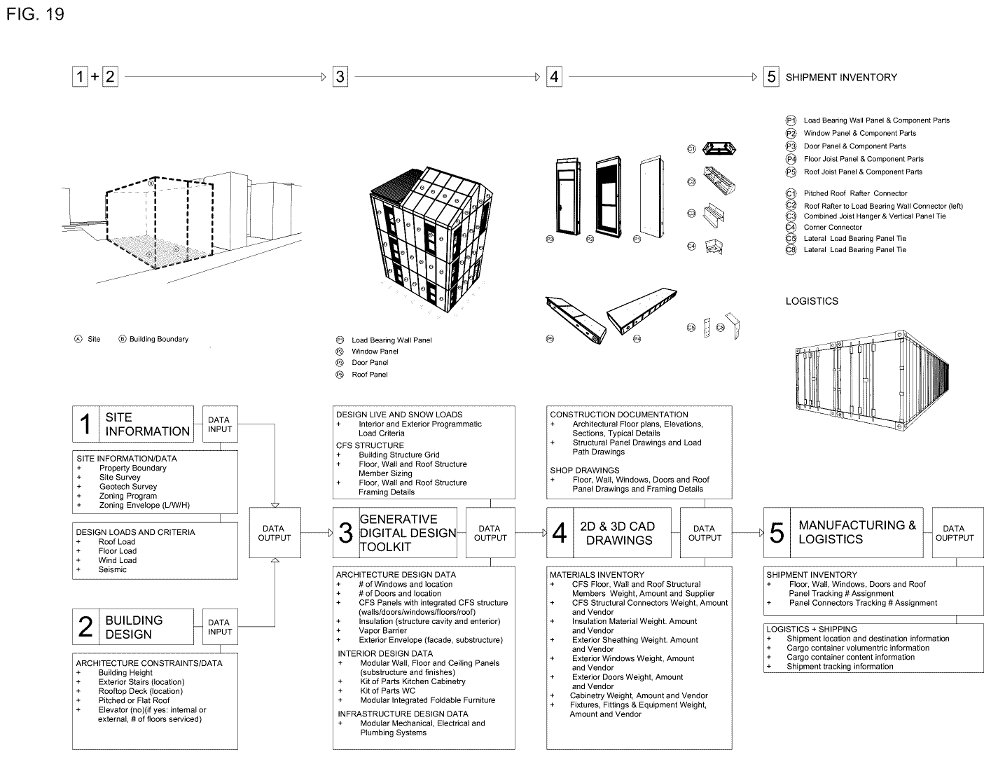

Both load bearing wall panels and roof panels make sure of external ties (FIG. 17, C8), (FIG. 18, C5), (FIG. 19. C4). The external ties are not load bearing and function as connectors which tie load bearing wall to other load bearing wall panels, to window panels, to door panels (FIGS. 2 & 18), to roof panels (FIG. 17) and to adjacent, perpendicular corner load bearing wall, window and door panels (FIG. 2, FIG. 19).

The Generative Digital Toolkit (FIG. 20) is an integrated management software platform which increases the efficiency across the entire design construction value chain, automating building design through use of a catalog of parts for the CFS structure, including: MEP systems (mechanical, electrical, plumbing), panel materials (i.e. shear board, insulation, interior wall finishes, exterior façade finishes, window types and dimensions, door types and dimensions)(FIGS. 3, 5, 8, and 11), city utilities hook ups information and locations (i.e. power, water, sewage, IOT) and interior cabinetry. The digital toolkit is based on inputs (FIGS. 20, 1 and 2) which are analyzed by a computer algorithm that outputs 2D and 3D CAD files, including: structural loads and drawings, building massing and envelope, building panel detail (i.e. floor, walls, doors, windows, roof), panel assemblage, materials indexing (including volume and mass of materials). The 2D and 3D CAD files output can be used by the EOR (engineer of record) and AOR (architect of record) for building submissions and approvals and by both the CFS manufacturer and panel assembly manufacturer. Platforms for generative building design are available from HYPAR, for example. (See, www.hypar.io). A person having ordinary skill in the art after having read this disclosure will know how to implement the inventive toolkit described herein on such a generative building design platform.

Information for each project site is entered (input) as data (FIG. 20, 1), including site survey information (Geotech survey info (i.e. soil and substrate data) and site boundaries), zoning information, including, but not limited to, height restrictions, adjacent site factors and constraints, urban planning zoning constraints (i.e. types of program, local and regional specific building requirements and constraints such as GFA (gross floor area) limits as stipulated by program and exemptions for certain types of program, etc.)).

Information for the building design constraints (FIG. 20, 2) are entered including building envelope dimensions (i.e. site boundary length, width and height measurements), number of windows, doors, variables such as pitched or flat roof, number of floors, inclusion of vertical transportation (i.e. elevators), GFA, NUA (net usable area) and efficiency targets.

The Generative Digital Design Toolkit (FIG. 20, 3) overlays additional data for structural loads, CFS engineering structural criteria (based on load calculations and CFS manufacturers profile specifications including track, stud and joist profile dimensions and gauge of steel and input as a series of constraints and variables) and architecture design data (building structural grid spacing, program plan layout requirements, interior and exterior finish materials and kitchen cabinetry requirements, restroom/WC requirements and other design specifications). All materials (i.e. structure, material finishes, insulation, shear panels, water proofing vapor barriers, flashing) are entered as a series of component variables.

An integrated 2D and 3D virtual model is generated from the information input (FIG. 20, 3), with 2d floor plan layouts corresponding to the 3d building model and vice versa. Adjustments for the size and locations of windows, doors, walls, floor panels, roof panels can be made by adjustments to the 2D or 3D drawing.

Once the building design is complete, the Generative Digital Toolkit compiles this information and outputs it as BIM and CAD digital files (FIG. 20, 5) for use by the EOR, AOR, CFS manufacturer, panel manufacturer and to prospective construction managers (CMs) and general contractors (GCs) as a part of, for example, a tender bidding process. All production of standardized panels (i.e. floor, walls, doors, windows, roof) are output in an excel file type of format for cargo shipment logistics tagging and tracking.

What is claimed is:

1. A system for prefabricated construction comprising:
a computer implemented design system accepting building design constraints data inputs including site data, regulatory data and building design data and outputting building design data including design drawings data and prefabricate building component data;
flat-pack construction components manufactured according to the building design data, including prefabricated panels; and
a plurality of connectors for manually joining selected ones of the prefabricated panels.

2. A method for building construction:
inputting in a computer implemented design system building design constraints data inputs including site data, regulatory data and building design data;
outputting from the computer implemented design system building design data including design drawings data and prefabricate building component data;
manufacturing flat-pack construction components manufactured according to the building design data, including prefabricated panels; and
manually joining selected ones of the prefabricated panels.
